(19) United States
(12) Patent Application Publication
(10) Pub. No.: US 2016/0245430 A1
(43) Pub. Date: Aug. 25, 2016

(54) Extensible flexible hose

(71) Applicants: Alessandro Mezzalira, Sandrigo (VI) (IT); Valentino Vigolo, Caldogno (VI) (IT); Luca Battaglia, Bassano del Grappa (VI) (IT); Andrea Petronilli, Carmignano di Brenta (PD) (IT); Marco Bucci, Baone (PD) (IT); Alessandro Cegalin, Vicenza (IT)

(72) Inventors: Alessandro Mezzalira, Sandrigo (VI) (IT); Valentino Vigolo, Caldogno (VI) (IT); Luca Battaglia, Bassano del Grappa (VI) (IT); Andrea Petronilli, Carmignano di Brenta (PD) (IT); Marco Bucci, Baone (PD) (IT); Alessandro Cegalin, Vicenza (IT)

(73) Assignee: FITT S.P.A., Sandrigo (VI) (IT)

(21) Appl. No.: 15/143,543

(22) Filed: Apr. 30, 2016

(51) Int. Cl. F16L 11/08

(52) U.S. Cl. CPC F16L 11/085

(57) ABSTRACT

A flexible hose for transporting a fluid, particularly a flexible garden hose for transporting water, includes an outer sheath and an inner tube. The inner tube has an inner layer made of a first elastic polymeric material and an outer layer made of a second elastic polymeric material with a textile reinforcement layer embedded within the inner tube to form a unitary tubular member. The elasticity of the unitary tubular member is such that it automatically elongates under the working pressure provided by a liquid flowing therethrough and automatically recovers its original length when the working pressure stops. The textile reinforcement layer is adapted to move from a rest configuration when there is no working pressure, to a working configuration when the unitary tubular member elongates under the working pressure.

### FIELD OF THE INVENTION

The present invention is relates to a flexible hoses, and more particularly relates to a flexible hose, preferably an irrigation hose or a garden hose for transporting water, which is extensible, or adapted to automatically elongate upon passage of a fluid and automatically retract when pressure from the fluid stops.

### DEFINITIONS

As used herein, the expression “textile reinforcement layer” or derivative thereof relates to a layer consisting of at least one textile yarn arranged on a layer that supports it. The “textile reinforcement layer” is disposed on the supporting layer to leave free portions thereof, generally square-, rectangular- or rhomboid- shaped.

As used herein, the expression “textile yarn” or derivative thereof relates to an elongated thread-like member of any shape and made of any material, provided that the magnitude of the length is significantly prevailing over the other. For example, the textile yarn may be a polymer yarn, which may have a unitary structure or may in turn consist of the union of several elementary threads, or a textile band having rectangular section.

As used herein, the expression “spiral textile layer” or “spiraling” or derivative thereof relates to a layer consisting of a single yarn wound as a spiral on the supporting layer with a predetermined pitch or groups of yarns wound as a spiral on the supporting layer non overlapping to each other.

As used herein, the expression “textile braided layer” or “braiding” or derivative thereof relates to a layer consisting of at least two yarns or groups of yarns wound as a spiral on the supporting layer with opposite inclinations and overlapping but not connected to each other. Therefore, a braiding consists of two or more overlapping spirals.

As used herein, the expression “textile knitted layer” or “knitting” or thereof relates to a layer consisting of at least two yarns or groups of yarns laying on the supporting layer and connected to each other to form a plurality of chain-like knit, also known as “tricot”-type chain knit.

As used herein, the expression “textile woven layer” or “weaving” or derivative thereof relates to a layer consisting of at least two yarns or groups of yarns laying on a supporting layer with opposite inclinations and connected to one another alternately to form a weave. In a weaving a yarn is interlaced with another yarn once above and then below the latter. Depending on the inclination, the weaving is also known as fabric.

As used herein, the expression “textile knotted layer” or “knotting” or derivative thereof relates to a layer consisting of at least two yarns or groups of yarns laying on the supporting layer with opposite inclinations and interconnected to each other by means of one or more knots. In a knotting a yarn cannot slide with respect to another due to the constraint imposed by the knots.

As used herein, the expression “compatible materials” or derivative thereof materials relates to having chemical and/or physical compatibility to each other, that is materials which once coupled give rise to a junction adapted to support the transfer of tensile or shear stresses through the contact surface. Therefore, identical materials or in any case materials having the matrix with the same base have the maximum compatibility.

As used herein, the expression “matrix” of a polymer or derivative thereof relates to a polymeric material capable of providing the molecular structure of the finished product.

As used herein, the expression “providing” or derivative thereof relates to the preparation of an element of interest to a process step of interest, thus including any preventive treatment act for the optimum exploiting of the same step of interest, from the simple withdrawal and possible storage to pre-heat and/or chemical and/or physical treatments and the like.

As used herein, the expression “film” or derivative thereof relates to a layer of polymeric material whose thickness is less than 0.5 mm.

### BACKGROUND OF THE INVENTION

Extensible flexible hoses for transporting liquids, such as irrigation water, are known, which automatically elongate upon the passage of a fluid inside the hose and automatically retract when the pressure of the fluid stops.

The working pressure of the transported fluid, such as a liquid, causes an elongation over its original length and a more or less apparent increase in the original diameter, so that the flexible hose is susceptible to transport the liquid at a greater distance with respect to its length when not in use.

In known manner, the automatic elongation is due to a restriction inside the hose or connected therewith, for example internal to a connector or to a diffuser or an irrigation lance.

The restriction creates a pressure drop such that the pressure upstream of the restriction acts inside the tube, thus elongating and enlarging it.

For example, an irrigation hose is known from US2003/0098084 that has an inner layer, an outer layer and a coil integrated therebetween. Under pressure from the transported liquid the spiral automatically extends, allowing the tube to elongate. Once the pressure of the liquid stops, the spiral automatically retracts, allowing the tube to resume its original length.

Apparently, this hose is difficult to manufacture, due to the presence of the coil. Furthermore, it is cumbersome and impractical to use. For example, it is difficult if not impossible to roll up the hose on a hose reel.

Another drawback of such a hose is that the burst pressure is relatively low. In fact, the resistance to the burst is exclusively imparted by the inner and outer polymeric layers.

Another extensible irrigation hose is known from EP2520840 that consists of an inner elastic tube and a rigid outer fabric. Under pressure from the transported liquid the inner tube elongates and enlarges its diameter up to a maximum length and a maximum diameter determined by the outer fabric. When the liquid pressure stops, the inner tube retracts, and the outer fabric lies in an undulated manner on the inner tube.

An apparent drawback of this hose is that it is difficult and expensive to manufacture. In fact, for each hose it is necessary to separately produce the inner tube and the outer fabric, then insert the first through the latter and then connect the tube and the fabric to each other through end fittings.

These operations are very difficult to perform in a continuous manner, and practically impossible to carry out in line, that is, by means of a single automatic production line. In fact, in order to manufacture such a hose, the use of human operators is needed.

Moreover, the presence of the fabric renders the hose bulky and unwieldy to use and store. For example, this tube is very difficult to store on a classic hose reel since the fabric occupies a relatively high space, much greater than the actual volume of the inner tube.

Further, the burst pressure is extremely low, because in practice it is only determined by the inner tube.

In addition, in case of breakage of the inner tube, such a hose is impossible to repair, and must be replaced with a new one.

For the same reason, it is not possible to customize the length of the tube, for example to obtain two hoses from a single longer hose.

Another known drawback of this known hose is that it must necessarily include the end fittings, since the outer fabric and the inner tube are elements independent of one another. Therefore, in case of breakage or simple damage to the original fittings the hose must be replaced with a new one.

This further limits the user's freedom in customizing the hose, since the original fittings cannot be replaced.

Further, the outer fabric tends to become dirty, making the use of such a hose very cumbersome and difficult. In fact, the textile fabric when dragged on a wet ground tends to collect mud and/or dirt and to get heavy. Moreover, after hardening the sludge adheres firmly to the fabric, thus increasing difficulty of use and storage of this known hose.

Other documents describing to the state of the art before the present invention are: U.S. Pat. No. 3,028,290, EP2778491, U.S. Pat. No. 4,009,734, WO2011/161576, WO00/77433, WO97/37829, GB740458, GB 1481227, US2003/0062114, WO2015/177664, US2014/0130930, US2013/0087205, FR2784447 and WO2013/105853.

### SUMMARY OF THE INVENTION

An object of the present invention is to overcome at least partially the above drawbacks, by providing an extensible flexible hose of remarkable efficiency and relative low cost.

Another object of the invention is to provide an extensible flexible hose which can be manufactured in a simple and fast manner.

Another object of the invention is to provide an extensible flexible hose which can be manufactured automatically in line.

Another object of the invention is to provide an extensible flexible hose which is wieldy to use.

Another object of the invention is to provide an extensible flexible hose from which is simple to remove any residual dirt and/or mud due to dragging on wet soils.

Another object of the invention is to provide an extensible flexible hose which has a relatively high burst pressure.

Another object of the invention is to provide an extensible flexible hose that has minimum bulk.

Another object of the invention is to provide an extensible flexible hose which is simple and practical to store.

Another object of the invention is to provide an extensible flexible hose that can be repaired in case of breakage.

Another object of the invention is to provide an extensible flexible hose that can be customized in length.

These and other objects are achieved by a flexible hose for transporting liquids, particularly an irrigation hose or garden hose for the transport of water as described hereinafter.

Advantageous embodiments of the invention are also described herein.

### BRIEF DESCRIPTION OF THE DRAWINGS

Further features and advantages of the invention will be apparent upon reading the detailed description of a preferred, non-exclusive embodiment of an extensible flexible hose and a production line for the manufacture thereof, which are described as non limiting examples with the support of the enclosed drawings, in which:

FIGS. 1 to 3 are schematic views of a hose according to the invention during use;

FIG. 4 is a schematic side view of an inner tube at rest;

FIG. 5 is a schematic side view of the inner tube 1 of FIG. 4 under pressure;

FIG. 6 is a schematic side view of a manufacturing line according to the invention;

FIG. 7 is a radial sectional view of the inner tube 1 of FIG. 4;

FIGS. 8 and 9 show two examples of a woven textile reinforcement layer;

FIG. 10 shows an example of a knotted textile reinforcement layer;

FIGS. 11A and 11B show a hose according to the invention, respectively at rest and under pressure;

FIGS. 12A and 12B show a hose according to the invention, respectively at rest and under pressure;

FIGS. 13A and 13B show a hose according to the invention, respectively at rest and under pressure;

FIGS. 14A and 14B show a hose according to the invention, respectively at rest and under pressure;

FIGS. 15A and 15B show an inner tube 1 according to the invention, respectively at rest and under pressure;

FIGS. 16A and 16B show an inner tube 1 according to the invention, respectively at rest and under pressure;

FIGS. 17A and 17B show a hose according to the invention, respectively at rest and under pressure;

FIGS. 18A and 18B show an inner tube according to the invention, respectively at rest and under pressure;

FIGS. 19A and 19B show an inner tube according to the invention, respectively at rest and under pressure;

FIGS. 20A and 20B show a hose according to the invention, respectively at rest and under pressure.

### DETAILED DESCRIPTION OF EMBODIMENTS OF THE INVENTION

With reference to the above figures, an extensible hose 200 is advantageously used for the transport of liquids. In particular, the extensible hose 200 may be an irrigation hose or garden hose for the transport of water.

The extensible hose 200 may include an outer sheath 70 and an inner tube 1.

The inner tube 1 may include an inner polymer layer 10 and an outer polymer layer 20.

Internally to the inner layer 10, a detaching film 11 may be provided susceptible to come in contact with the liquid to be transported, the function of which will be explained later.

The inner tube 1 may further include a first inner knitted textile layer 30 with a tricot-type chain knits and a second braided textile layer 40, mutually overlapping. The pitch of the spirals of the second braiding textile layer 40 may be relatively short, for example 1 mm to 3 mm.

The inner tube 1 may further include one intermediate polymeric layer 15 interposed between the textile reinforcement layers 30 and 40 for the separation thereof.

It is to be understood that although the following description relates to an inner tube 1 with the above structure, the inner tube may include three or more layers.

For example, a single textile reinforcement layer may be provided, or one or more additional polymeric layers internal or external to the above layers.

It is also to be understood that although the following description relates to an inner tube 1 with the above structure, the technical features herein described are applicable to an inner tube which includes at least three layers.

It is further to be understood that although reference is made here to a garden hose for the transport of water, the hose 200 can have any application and can transport any liquid or other fluid.

In a preferred but not exclusive embodiment, inner layer 10, intermediate layer 15 and outer layer 20 may be made of a styrene-based thermoplastic elastomer (TPE-S) having a matrix based on polypropylene (PP), for example the Nilflex® SH (Taro Plast SpA), having a Shore A hardness measured according to ASTM D2240 (3″) of 40. Such a material has a tensile strength measured according to ASTM D412/C of about 6.5 MPa and an elongation at break measured according to ASTM D412/C of approximately 880%.

Indicatively, the inner layer 10 may have a thickness of 1.5 mm to 2.5 mm, preferably 1.6 mm-2 mm. On the other hand, the film 11 may have a thickness of 0.05 mm to 0.4 mm, preferably 0.1 mm-0.3 mm.

Preferably, the detaching film 11 also may be made of the same above described material, to which a small percentage of lubricant-release additive agent may be added.

For example, a material that may be added for about 1% by weight total is CRODAMIDE® (CRODA Polymer Additives), a migrant agent who has the purpose of decreasing friction and blocking the material on itself.

In a preferred but not exclusive embodiment, the textile reinforcement layers 30 and 40 may be made of polyester (PET)-based yarns, for example Brilen GLE® (Brilen Tech SA) having a linear density of 550 dtex. Such yarns have an ultimate tensile strength, measured according to BISFA (Chap 7), of 42.7+/−4.2 N, an elongation at break measured according to BISFA (Chap 7) of 12.5+/−2.5% and toughness measured according BISFA (Chap 7) of 75.5+/−7 cN/tex.

The first textile reinforcement layer 30 may be placed on the outer surface 12 of the inner layer 10 so as to leave thereon a plurality of open areas 13, which are directly facing the corresponding portions of the inner surface 16 of the intermediate layer 15.

On the other hand, the second textile reinforcement layer 40 may be placed on the outer surface 12′ of the intermediate layer 15 so as to leave thereon a plurality of open areas 13′, which are directly facing the corresponding portions of the inner surface 21 of the outer layer 20.

Suitably, the inner layer 10, intermediate layer 15 and outer layer 20 may be reciprocally bonded in correspondence with the respective uncovered areas 13, 13′.

The bond between the inner layer 10, intermediate layer 15 and outer layer 20 may be assured by the use of materials compatible with each other or by a layer of adhesive material interposed between them.

To effect such a coupling, the inner layer 10, intermediate layer 15 and outer layer 20 form a unitary tubular member 50, inside of which the reinforcing textile layers 30 and 40 may be integrated or embedded.

The possible choice of the same material for all the polymeric layers of the inner tube makes the mechanical behavior of the unitary tubular member 50 homogeneous, and ensures maximum compatibility between the materials.

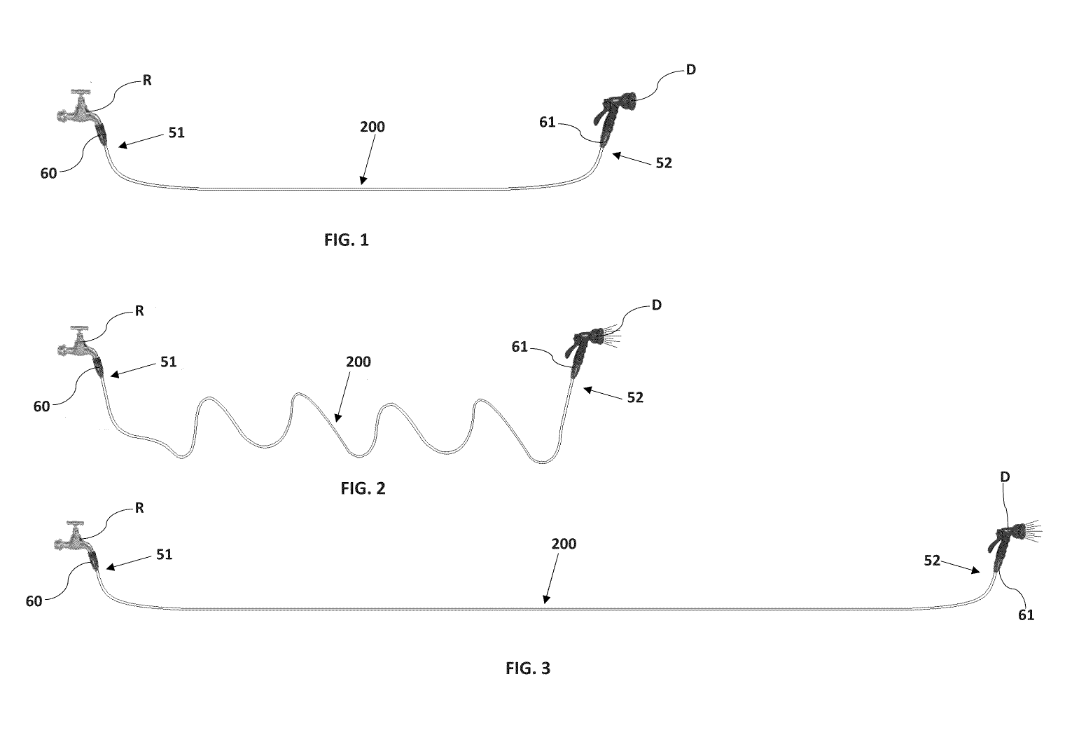

As particularly shown in FIGS. 1-3, at the ends 51, 52 of the hose 200 appropriate mutual union elements may be provided.

For example, respective couplers 60, 61 may be provided.

In a preferred but not exclusive embodiment, the coupler 60 may be e.g. a female coupler, and may be adapted to connect the hose 200 to a point of use, for example a hose bibb R. On the other hand, the coupler 61 may be a male coupler, and may be adapted to connect the hose 200 to one or more sprinkler accessories D, for example a lance or a sprinkler.

In another embodiment, the end 52 of the hose 200 may be fixedly coupled to the sprinkler accessory D, for example a lance or a sprinkler. In this case, the hose 200 does not include the coupler 61, and cannot be coupled to more sprinkler accessories. At the other end 51 the coupler 60 may be provided for connecting the hose 200 to a point of use, for example a tap R.

Due to the above features, the inner tube 1 may be susceptible to automatically expand under the working pressure imparted by the water that flows within it, thus increasing its original length and diameter.

To achieve this, at least one restriction inside the hose or connected therewith may be provided as known in the art.

In a preferred but not exclusively embodiment, the at least one restriction may be defined by a flow restrictor as known in the art located inside the coupler 61.

On the other hand, the inner tube 1 may internally include one or more restrictions, such as thickened portions or the like.

The at least one restriction may also be provided in the sprinkler accessory D, for example a lance or a sprinkler.

The at least one restriction may create a pressure drop such that the pressure upstream of it acts internally to the inner tube 1, thus axially elongating inner tube 1 along the axis X and radially enlarging it perpendicularly to the same axis X.

In practice, after the hose 200 is connected to a point of use, for example to a hose bibb R, upon the opening of the hose bibb the water that passes through the inner tube 1 promotes its axial elongation and radial enlargement, as shown in FIGS. 2 and 3.

In other words, the water flow promotes the passage of the inner tube 1 from an original length and diameter (FIG. 1), that the same inner tube 1 has when no water passes through it, to a working length and the diameter (FIG. 3).

The transition from the original diameter and length to the working diameter and length occurs gradually, passing through an intermediate stage, shown in FIG. 2, in which the hose starts to enlarge and elongate under the thrust of the water pressure.

By contrast, upon the closing of the hose bibb R the hose 200 automatically retracts, thus returning to its original length and diameter.

In order to achieve the above, the unitary tubular member 50 and the textile layers 30, 40 can cooperate with each other.

More precisely, the unitary tubular member 50 may have such an elasticity that it lengthens automatically under the working pressure imparted by the water and retracts automatically after the working pressure stops.

Moreover, due to its elasticity, under the working pressure the unitary tubular member 50 may radially enlarge to increase its original diameter and then automatically retract after the working pressure stops.

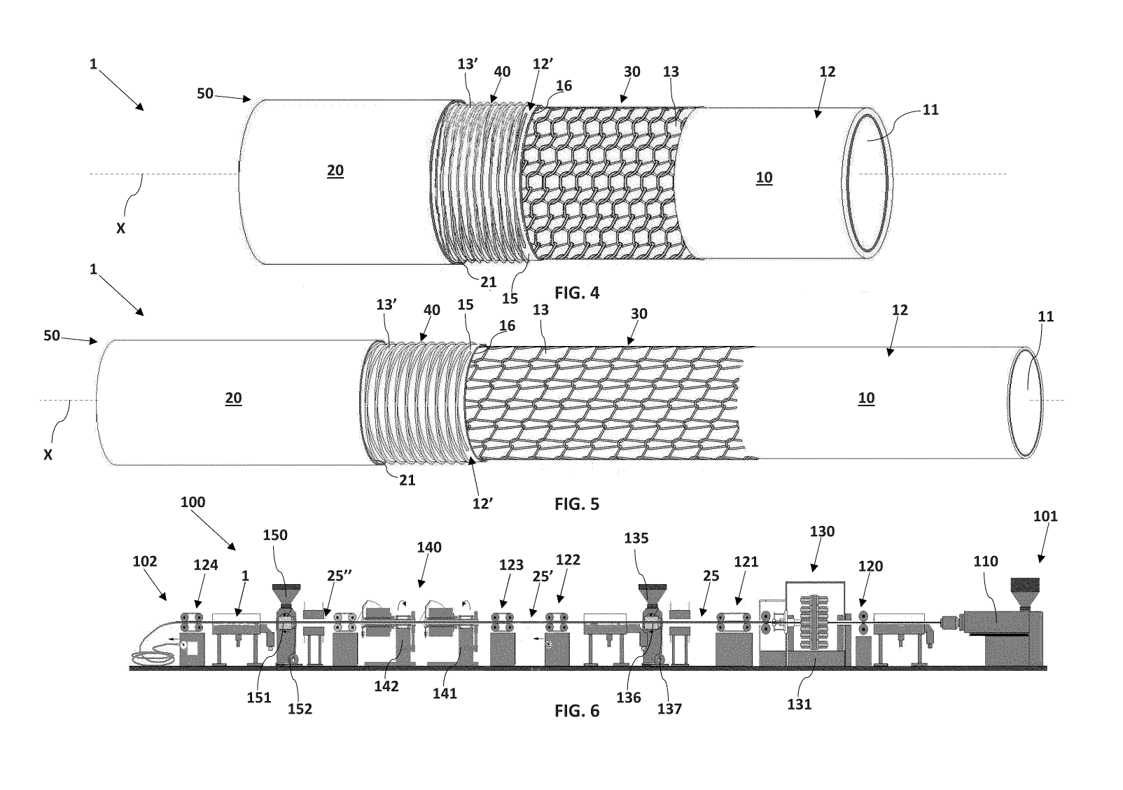

On the other hand, the elongation and the enlargement of the unitary tubular member 50 promotes the passage of the textile reinforcement layers 30, 40 from a rest configuration, shown in FIG. 4, which they have when no water flows through the inner tube to a working configuration, shown in FIG. 5, which they have under the working pressure.

Conversely, after the working pressure stops the automatic retraction of the unitary tubular member 50 returns the textile reinforcement layers 30, 40 to their rest configuration.

Under the working pressure, in addition to increasing the length and diameter of the inner tube, a thinning of the entire thickness thereof further occurs. With the above described configuration and materials, the wall thickness under pressure decreases by about half.

The first textile reinforcement layer 30 may be configured to intercept the unitary tubular member 50 upon its elongation to determine the maximum length.

Similarly, the second textile layer 40 may be configured to intercept the unitary tubular member 50 upon its enlargement or radial expansion in order to determine the maximum diameter.

To do this, the yarn of the textile reinforcement layers 30, 40 and the materials of the unitary tubular member 50 may be suitably selected, for example as described above.

The second textile reinforcement layer 40 may be placed externally with respect to the first textile reinforcement layer 30.

In fact, because of its configuration the first textile reinforcement layer 30 tends to restrain the axial elongation but to yield in the radial direction. By contrast, the second textile reinforcement layer 40 tends to restrain the radial enlargement but to yield in the axial direction. The cooperation of the two textile reinforcement layers 30, 40 enables restraining the expansion of the inner tube in both axial and radial directions, thus determining the maximum length and diameter.

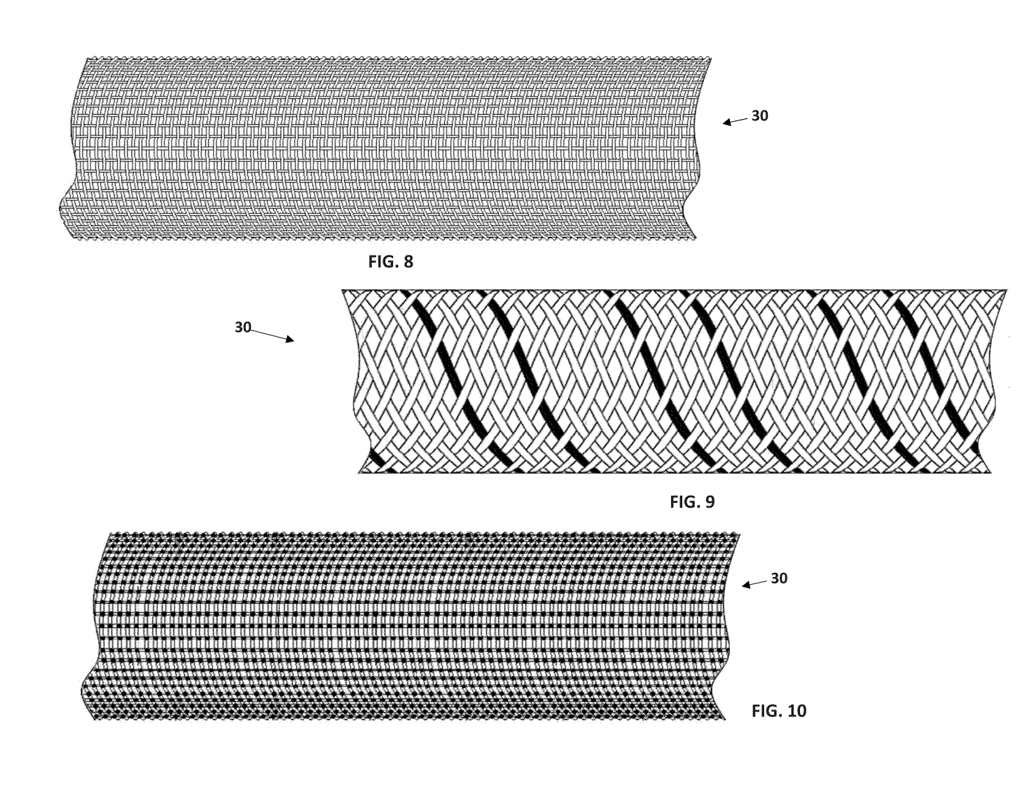

In alternative to the knitted configuration, the first textile reinforcement layer 30 may be woven or knotted. FIGS. 8 and 9 show two examples of a textile reinforcement woven layer, different from each other for orientation, number and configuration of the yarns. FIG. 10 shows an example of a textile reinforcement knotted layer.

On the other hand, the second textile reinforcement layer 40 may consist of one or more spirals, in other words of one single spiral or a braiding.

Suitably, the unitary tubular member 50 and the textile reinforcement layers 30, 40 may cooperate with each other so that under a working pressure of 2 bar the inner tube 1 is susceptible to increase its length at least 1.5 times with respect to the its original length, preferably at least 2 times with respect to its original length, and more preferably of at least 2.5 times with respect to its original length.

For example, with an inner tube having the structure described above and manufactured from the above materials, with an inner diameter at rest of 9 mm, outer diameter at rest of 14 mm and weight of 80 g/mt, the elongations at different internal working pressures are provided in Table 1 below.

TABLE 1

| Working pressure (bar) | Length under pressure: original length |
|---|---|
| 2 | 2 |
| 3 | 2.2 |
| 4 | 2.4 |
| 5 | 2.4 |
| 6 | 2.5 |

For such an inner tube, the radial expansion with respect to the diameter at rest at the working pressure of 3 bars is 0.8 mm, whereas at the working pressure of 5 bar is 1 mm.

It is understood that these data may change depending on the materials and/or the features of the inner tube, such as the inner or outer diameter or the weight/mt thereof.

Advantageously, the radial enlargement of the inner diameter of the inner tube of the present invention under a working pressure of 5 bar may be less than 20% with respect to the value of the inner diameter at rest, and preferably less than 15% with respect to the value of the inner diameter at rest.

In a preferred but not exclusive embodiment, the outer layer 20 may be a protective film, of which the weight per meter may be 3% to 10% of the total weight of the unitary tubular member 50, for example 5% of the total weight of the unitary tubular member 50.

Preferably, the film 20 may be made in accordance with the teachings of international application PCT/IB2014/067091, to which one may refer for consultation.

Indicatively, the film 20 may have a thickness of 0.05 mm to 0.4 mm, preferably 0.1 mm-0.3 mm.

This film 20 has the purpose of protecting the underlying layers, in particular the textile layers, and to give appearance to the inner tube. It is also important for resistance to external agents and the sliding of the inner tube on the ground. In fact, it minimizes fouling of the inner tube as a result of the use on muddy grounds or in a garden.

Similarly, the intermediate layer 15 may also be a film having the same features of the outer film 20.

The inner tube 1 can be manufactured by means of a line 100, which works continuously.

The line 100 can be fed by the inner layer 10, which can for example be extruded through a first extruder 110 at the inlet 101 of the line 100.

In a known manner, the extruder 110 may co-extrude the inner layer 10 and the detaching film 11, which may then pass through a first pair of faced rotating rollers 120 configured to press the inner tube.

Subsequently, the inner layer 10 and the detaching film 11 may pass through a first station 130 for making the textile reinforcement layer 30, to obtain a first semi-finished product 25.

The station 130 may include a knitting machine 131, of a known type, to make the first textile knitted layer with knits of the tricot type 30, for example of the plain stitch type.

Subsequently, the first semi-finished product 25 may pass through a second pair of faced rotating rollers 121 configured to press the inner tube.

The rollers 121 may rotate faster than the roller 120, and the ratio between the speed of the first upstream roller 120 and the speed of the second downstream rollers 121 may be of 1:2 to 1:5, and more preferably of 1:3 to 1:5.

In this way, the two pairs of rollers 120, 121 continuously elongate the inner layer 10 with the inner film 11, so that the textile reinforcement layer 30 is made on the elongated inner layer 10.

Subsequently, the semi-finished product 25 may pass through a second extruder 135, which extrudes a film constituting the above intermediate layer 15. Advantageously, in accordance with the teachings of international application PCT/IB2014/067091, the extrusion head 136 of the extrusion station 135 may be placed under vacuum by a vacuum pump 137, for example at a pressure of 250-400 mmHg.

The second semi-finished product 25′ at the outlet of the second extruder 135 passes through a third pair of faced rotating rollers 122 configured to press the inner tube. The rollers 122 may rotate at substantially the same speed of the rollers 121, or slightly higher.

In this way, the film 15 is extruded on the textile reinforcement layer 30 in the elongated working configuration.

Subsequently, the second semi-finished product 25′ at the outlet of the rollers 122 passes through a fourth pair of faced rotating rollers 123 configured to press the inner tube. The rollers 123 rotate more slowly than the roller 122.

The ratio between the speed of the fourth upstream rollers 123 and that of the third downstream rollers 122 may be of 2:1 to 5:1, and preferably of 3:1 to 5:1.

In this way, the semi-finished product 25′ returns in a rest configuration, in which the layers 10, 11 and 15 have the original length and the textile reinforcement knitted layer 30 is in the rest configuration.

The semi-finished product 25′ in the rest configuration may be fed to a second station 140 for making thereon the textile reinforcement layer 40.

The station 140 may include a pair of spiraling machines 141, 142, to make a corresponding pair of spirals one in a clockwise direction and the other one in the opposite direction. The set of the two spirals constitutes the textile reinforcement layer 40.

The third semi-finished product 25″ at the outlet of the station 140 may then be fed to a third extruder 150, which may make the film 20. Similarly to what has been described for the second extruder 135, in accordance with the teachings of international application PCT/IB2014/067091, the extrusion head 151 may be placed under vacuum by a vacuum pump 152, for example at a pressure of 250-400 mmHg.

Upon extrusion, the inner layer 10, the intermediate film 15 and the outer film 20 adhere to each other at the uncovered areas 13, 13′ to form the unitary tubular member 50. In this way, the textile reinforcement layers 30, 40 remain embedded therein.

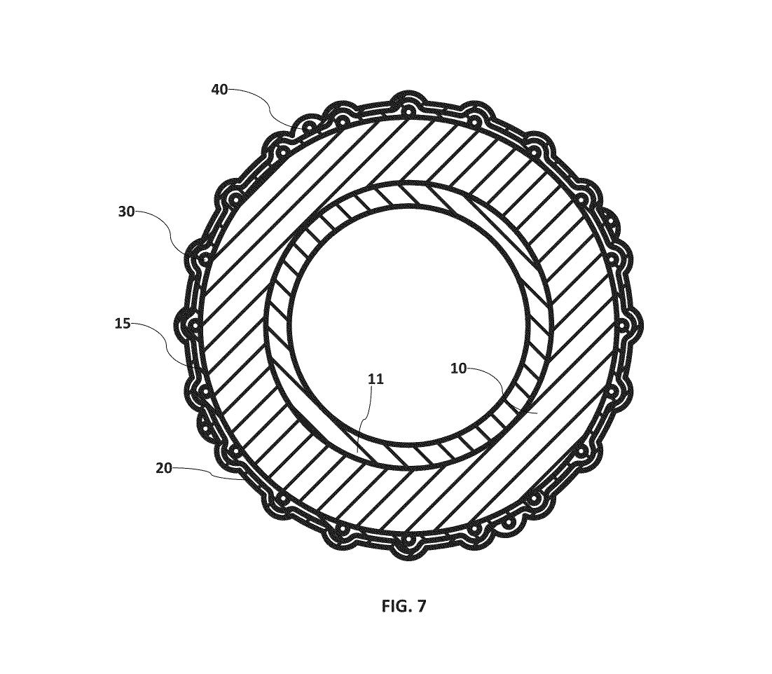

Because the intermediate film 15 and the outer film 20 are made in accordance with the teachings of international application PCT/IB2014/067091, the same intermediate film 15 and the outer film 20 have a uniform thickness and adhere strongly to the underlying layer, as shown in FIG. 7.

This minimizes material waste and gives an optimum aesthetic finish to the inner tube 1.

The inner tube 1 thus produced may then pass through a fifth pair of faced rotating rollers 124 configured to press the inner tube.

Advantageously, the rollers 124 may rotate at substantially the same speed of the rollers 123, or slightly higher.

In this way, the second textile layer 40 and the film 20 are made on the semi-finished products 25′ and 25″ in the rest configuration.

The detaching film 11 enables the detachment of the inner wall of the inner tube 1 after pressing immediately upon passage through the rollers 120, 121, 122, 123 and 124.

In a preferred but not exclusive embodiment, the second textile layer 40 and the film 20 can also be made on the semi-finished product 25′ in the elongated configuration. To do this, the rollers downstream the station 140 and the extruder 150 rotate faster than the ones upstream thereof, preferably in the above ratios.

In this case, the inner diameter of the elongated semi-finished product 25′ may preferably be brought to the inner diameter of the inner tube at rest by blowing air at adequate pressure.

To do this, suitable means may be provided for blowing air, of a known type, at the outlet 102 of the line 100.

The rollers 120, 121, 122, 123 and 124 may be mutually configured so that the air blown at the outlet 102 goes back up through the inner tube in correspondence of the rollers 121.

It is understood that in the line 100 in place of the rollers 120, 121, 122, 123 and 124 any rotary conveying device may be employed without departing from the scope of the appended claims.

The outer sheath 70 may have any configuration, and may be made of any material. The outer sheath 70 and the inner tube 1 may be connected to each other in correspondence of the couplers 60, 61. Apart the latter points, the outer sheath 70 and the inner tube 1 may be unconnected along the entire length of the hose or may be connected to each other at other points along the length of the hose.

For example, outer sheath 70 may be a fabric made of polyester or polyamide, or may be made of a polymer, for example a thermoplastic polymer, an elastomer or a thermoplastic elastomer. In another embodiment, the outer sheath 70 may be made of yarns to form a net, a braid of a knitting.

In general, the outer sheath 70 may be continuous or may be provided with one or more passing-through apertures.

The outer sheath 70 may be rigid or elastic. In any case, the outer sheath 70 matches the elongation of the inner tube 1.

Therefore, in case of a rigid outer sheath 70, the length thereof must be sufficient to match the elongation of the inner tube 1. On the other side, in case of elastic outer sheath 70 the elasticity thereof must be sufficient to impart to the same outer sheath 70 an elongation that matches the elongation of the inner tube 1.

The outer sheath 70 may includes only rigid yarns, only elastic yarns or a mixture thereof, in any relative amount.

In another embodiment, the outer sheath 70 may configured to elongate in the axial direction and to not enlarge in the radial direction. To this end, the outer sheath 70 may preferably include rigid yarns in the radial direction and elastic yarns in the axial direction.

The outer sheath 70 may have any diameter, for example an inner diameter matching the outer diameter of the inner tube 1 or a diameter greater than the outer diameter of the inner tube. In the latter case a rigid outer sheath 70 determines the diameter of the entire hose.

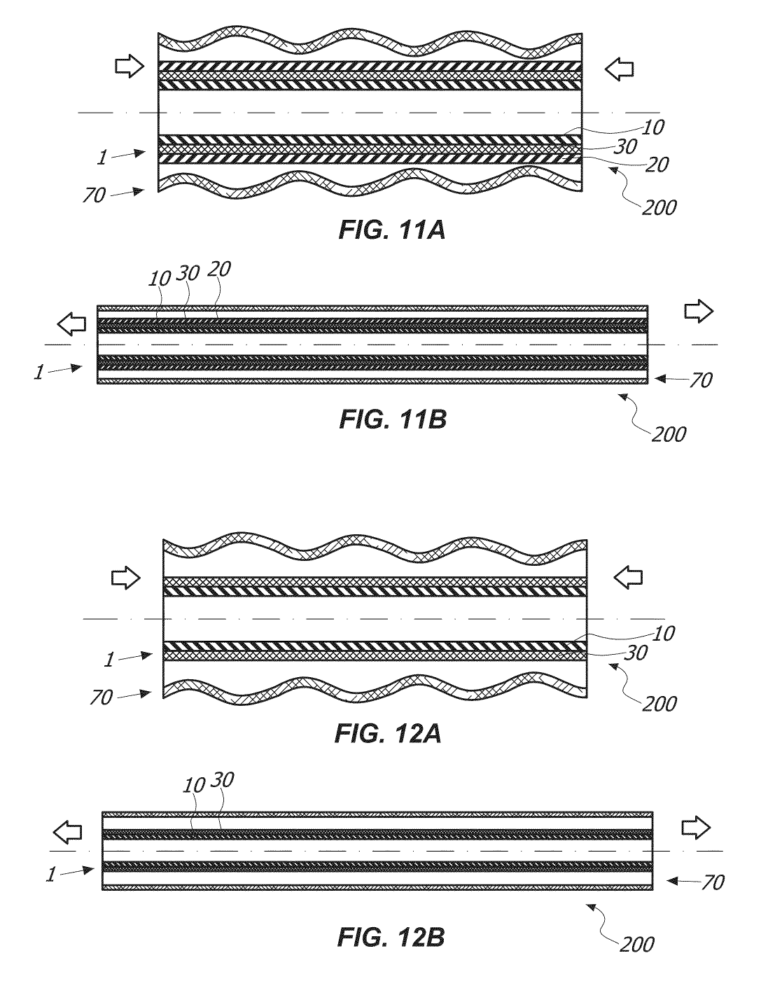

FIGS. 11A to 20B show a number of embodiments of the hose 1 or the inner tube 200. In any embodiment all the materials of the outer sheath 70 and of the inner tube 1 may be the same as described above. In any of these embodiments the one or more textile reinforcement layers may have any configuration, as described above. For example, it may be a braid, a spiral or a knitting.

FIGS. 11A and 11B show an embodiment of the hose 200 having an outer sheath 70 and an inner tube 1 which consists of three layers, an inner layer 10, an intermediate textile reinforcement layer 30 and an outer layer 20.

FIGS. 12A and 12B show an embodiment of the hose 200 having an outer sheath 70 and an inner tube 1 which consists of two layers, an inner layer 10 and an outer textile reinforcement layer 30.

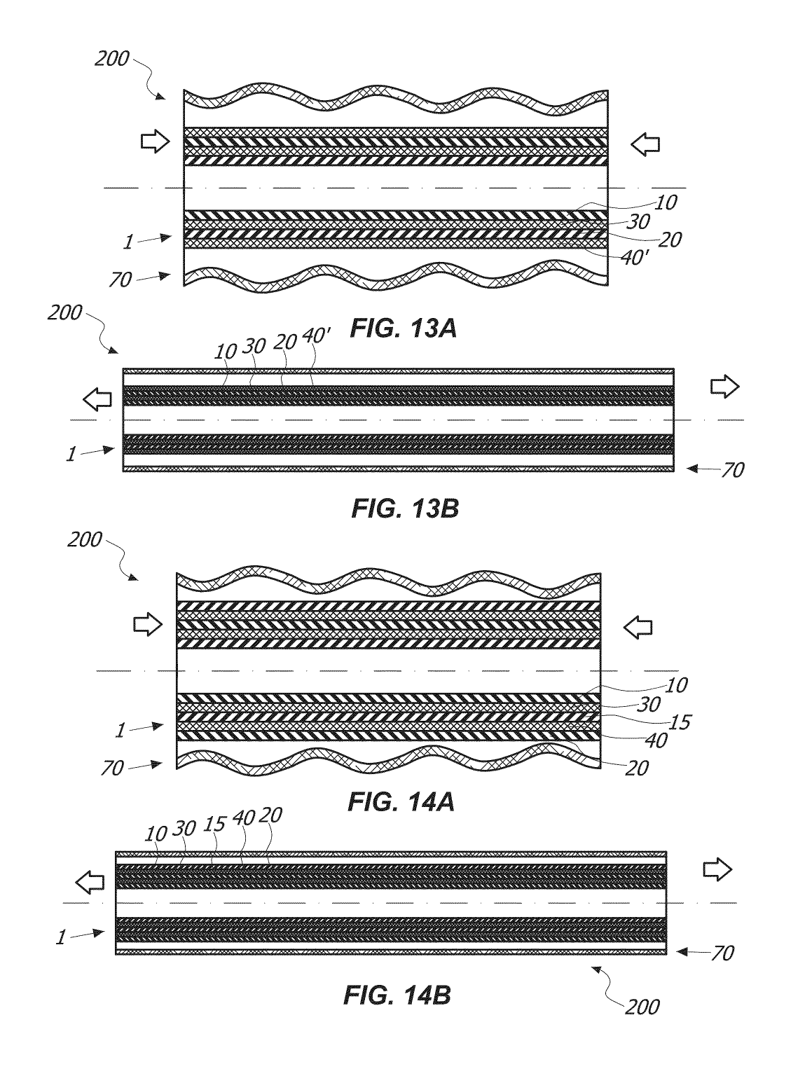

FIGS. 13A and 13B show an embodiment of the hose 200 having an outer sheath 70 and an inner tube 1 which consists of four layers, an inner layer 10, a first textile reinforcement layer 30, an outer layer 20 and a further textile reinforcement layer 40′.

FIGS. 14A and 14B show an embodiment of the hose 200 having an outer sheath 70 and an inner tube 1 which consists of five layers, an inner layer 10, a first textile reinforcement layer 30, an intermediate layer 15, a second textile reinforcement layer 40 and an outer layer 20. The inner tube 1 may be configured as described above, e.g. as shown in FIGS. 3 and 4, or in any other configuration. For example, the first textile reinforcement layer 30 and the second textile reinforcement layer 40 may be two knittings or two braidings.

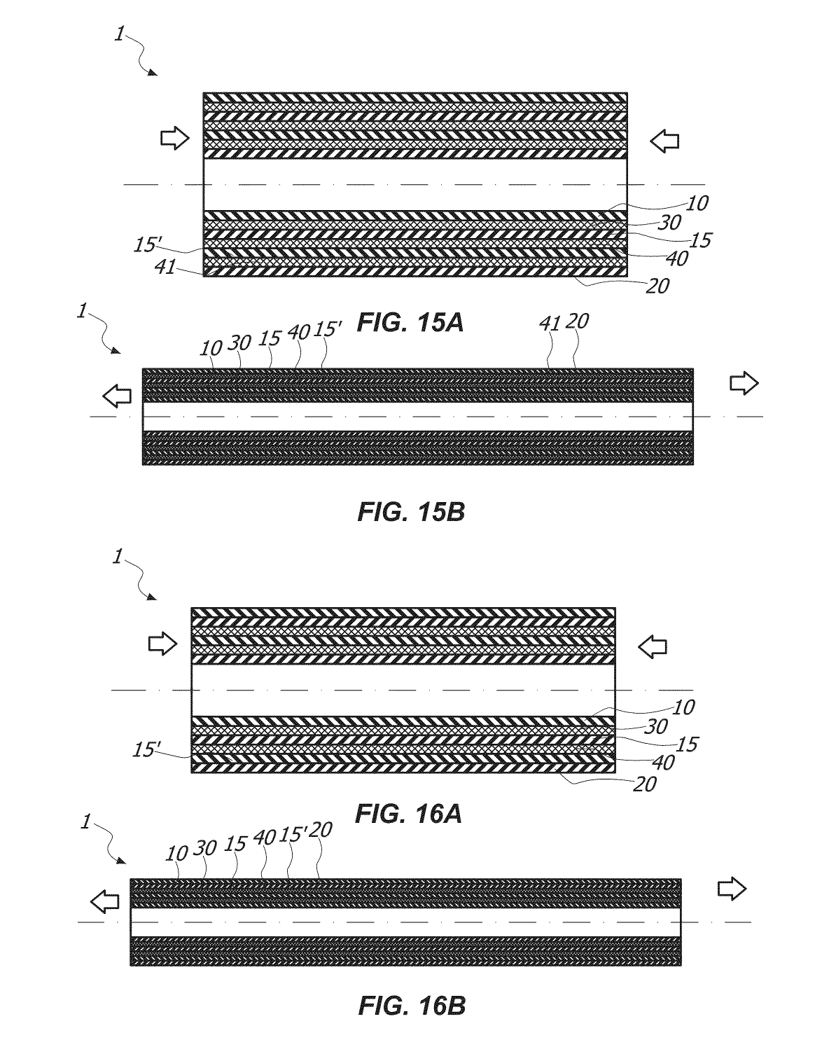

FIGS. 15A and 15B show an embodiment of the inner tube 1 consisting of seven layers, an inner layer 10, a first textile reinforcement layer 30, an intermediate layer 15, a second textile reinforcement layer 40, a further intermediate layer 15′, a further textile reinforcement layer 41 and an outer layer 20.

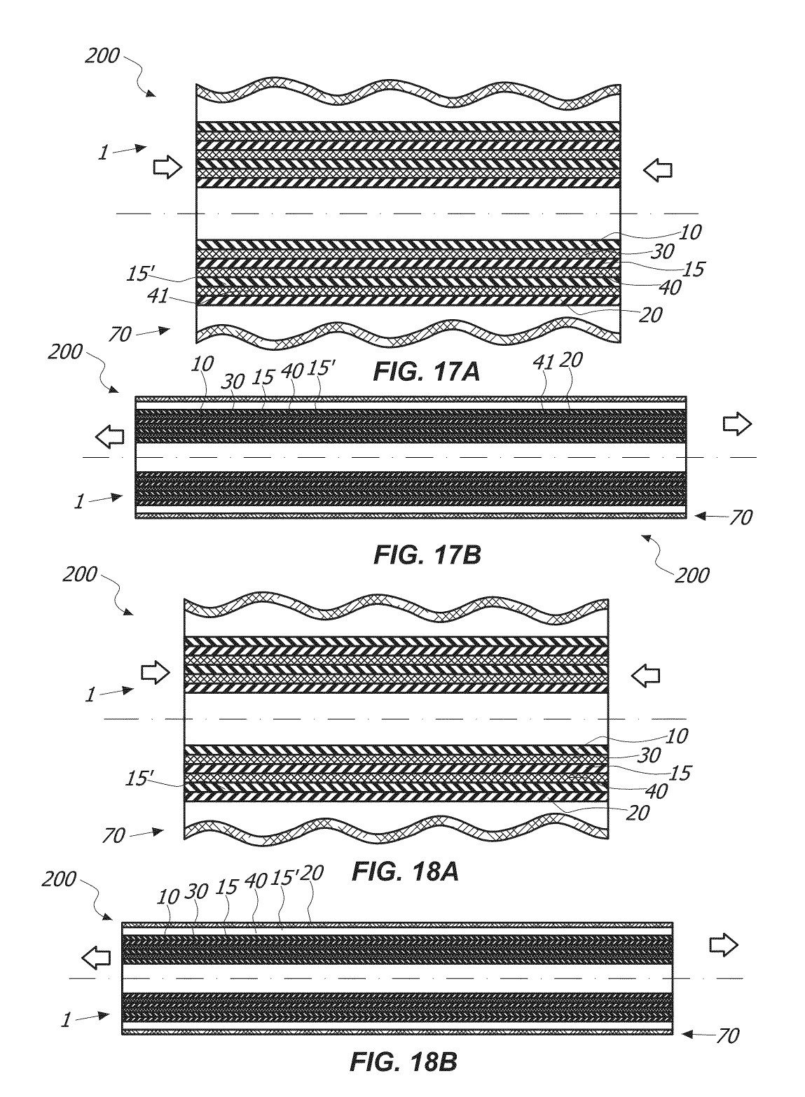

FIGS. 17A and 17B show an embodiment of the hose 200 having an outer sheath 70 and an inner tube 1 configured as shown in FIGS. 15A and 15B, as described above. It is understood that the inner tube 1 may be used as such, e.g. without the outer sheath 70, as depicted in FIGS. 15A and 15B.

FIGS. 16A and 16B show an embodiment of the inner tube 1 consisting of six layers, an inner layer 10, a first textile reinforcement layer 30, an intermediate layer 15, a second textile reinforcement layer 40, a further intermediate layer 15′ and an outer layer 20.

FIGS. 18A and 18B show an embodiment of the hose 200 having an outer sheath 70 and an inner tube 1 configured as shown in FIGS. 16A and 16B, as described above. It is understood that the inner tube 1 may be used as such, e.g. without the outer sheath 70, as depicted in FIGS. 16A and 16B.

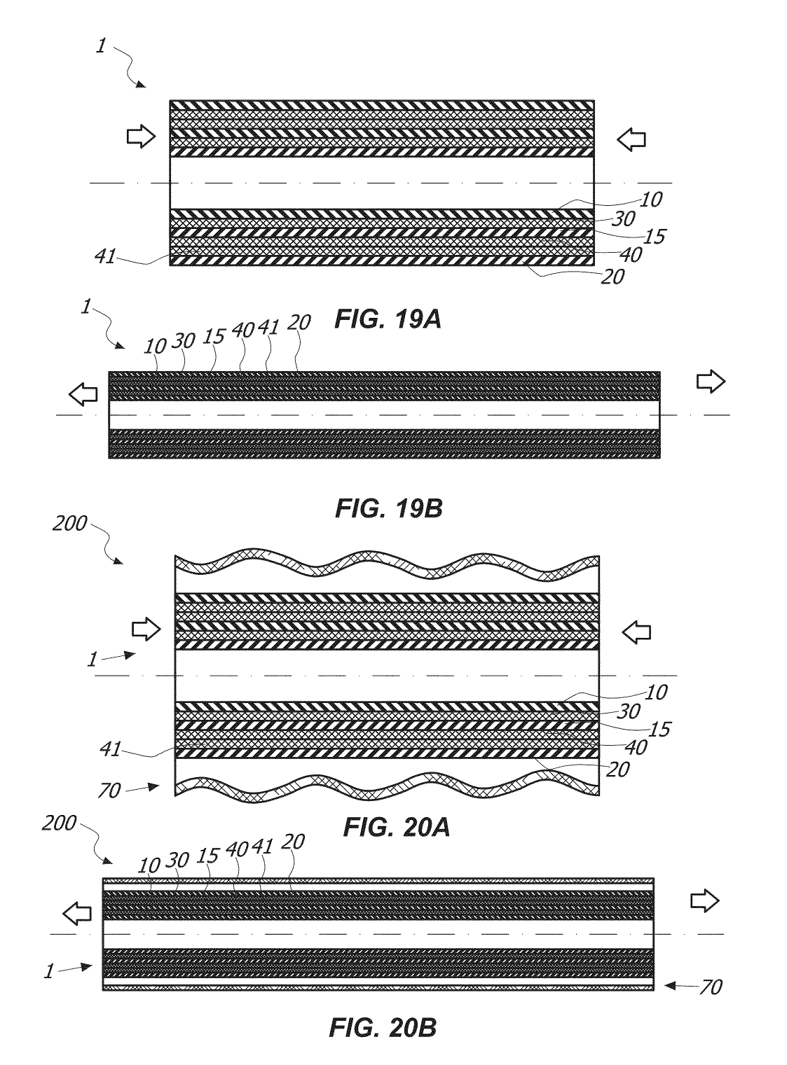

FIGS. 19A and 19B show an embodiment of the inner tube 1 consisting of six layers, an inner layer 10, a first textile reinforcement layer 30, an intermediate layer 15, a second textile reinforcement layer 40, a further textile reinforcement layer 41 and an outer layer 20.

FIGS. 20A and 20B show an embodiment of the hose 200 having an outer sheath 70 and an inner tube 1 configured as shown in FIGS. 19A and 19B, as described above. It is understood that the inner tube 1 may be used as such, e.g. without the outer sheath 70, as depicted in FIGS. 19A and 19B.

From the above description, it is apparent that the invention fulfils the intended objects.

The invention is susceptible of numerous modifications and variations, all falling within the inventive concept expressed in the attached claims. All the details may be replaced with other technically equivalent elements, and the materials may be different according to requirements, without departing from the scope of the invention.

Although the invention has been described with particular reference to the attached figures, the reference numbers in the description and in the claims are used to improve the intelligence of the invention and are not to be interpreted as limitations of the claimed scope.

The invention claimed is:

1. An extensible flexible hose for transporting liquids, comprising:
an outer sheath; and
an inner tube;
wherein the inner tube includes:
an inner layer made of a first elastic polymeric material,
an outer layer made of a second elastic polymeric material, and
a textile reinforcement layer interposed between the inner layer and the outer layer;
wherein the inner layer and outer layer are reciprocally coupled to form a unitary tubular member, the textile reinforcement layer being embedded therein;
wherein the unitary tubular member has an elasticity adapted to cause the unitary tubular member to automatically elongate and enlarge under a working pressure given by a liquid flowing therethrough, thereby increasing an original length and diameter of the unitary tubular member, and to automatically recover the original length and diameter after the working pressure stops, thereby assuming again the original length and diameter;
wherein the textile reinforcement layer is adapted to move between a rest configuration, when no liquid flows through the unitary tubular member, and a working configuration, when the unitary tubular member elongates and enlarges upon the working pressure; and
wherein the unitary tubular member and the textile reinforcement layer cooperate with each other to cause the inner tube to increases its length by at least 1.5 times over its original length under a working pressure of 2 bar.

2. The hose according to claim 1, wherein the automatic elongation and enlargement of the unitary tubular member causes the textile reinforcement layer to move from the rest configuration to the working configuration, and wherein the automatic recovery of the unitary tubular member causes the textile reinforcement layer to move back from the working configuration to the rest configuration.

3. The hose according to claim 1, wherein the textile reinforcement layer and the unitary tubular member are reciprocally configured to cause the textile reinforcement layer to capture the unitary tubular member upon its elongation and enlargement so as to define a maximum length and diameter thereof.

4. The hose according to claim 1, wherein the textile reinforcement layer lays on an outer surface of the inner layer so as to leave thereon a plurality of uncovered areas, the outer layer and inner layer being reciprocally coupled at the uncovered areas.

5. The hose according to claim 1, wherein the unitary tubular member has the original diameter and the original length when the textile reinforcement layer is in the rest configuration, the unitary tubular member being enlarged and elongated when the textile reinforcement layer is in the working configuration.

6. The hose according to claim 1, wherein textile reinforcement layer comprises a first textile reinforcement layer and a second textile reinforcement layer, the first textile reinforcement layer and the unitary tubular member being reciprocally configured so that the first textile reinforcement layer captures the unitary tubular member upon an elongation of the unitary tubular member to define a maximum length, the second textile reinforcement layer and the unitary tubular member being reciprocally configured so that the second textile reinforcement layer captures the unitary tubular member upon an enlargement of the unitary tubular member to define a maximum diameter.

7. The hose according to claim 6, wherein the second textile reinforcement layer is externally placed with respect to the first textile reinforcement layer, the first textile reinforcement layer being knitted, woven, or knotted, the second textile reinforcement layer being configured as a spiral or a braiding.

8. The hose according to claim 1, further comprising a restriction or a flow restrictor that create within the hose the working pressure that promotes the automatic elongation and the enlargement of the hose, said restriction or flow restrictor being internal to the hose or connected therewith.

9. The hose according to claim 1, wherein said first and said second elastic polymeric materials are elastomers.

10. The hose according to claim 1, further including a pair of couplers, the outer sheath and the inner tube being connected to each other at their ends in correspondence of the couplers.

11. The hose according to claim 10, wherein the outer sheath and the inner tube are unconnected along an entire length of the hose.

12. The hose according to claim 1, wherein the outer sheath is made of a fabric.

13. The hose according to claim 1, wherein the outer sheath is made of a polymer.

14. The hose according to claim 1, wherein the outer sheath is made of yarns that form a net, a braid or a knitting.

15. The hose according to claim 1, wherein the outer sheath is continuous.

16. The hose according to claim 1, wherein the outer sheath is provided with one or more pass-through apertures.

17. The hose according to claim 1, wherein the outer sheath is rigid.

18. The hose according to claim 1, wherein the outer sheath is elastic.

19. The hose according to claim 1, wherein the outer sheath matches an elongation of the inner tube.

20. The hose according to claim 1, wherein the outer sheath includes both rigid yarns and elastic yarns.
